(19) United States
(12) Patent Application Publication
(10) Pub. No.: US 2009/0035504 A1
(43) Pub. Date: Feb. 5, 2009

(54) WELDED CRYSTAL, SYSTEM AND METHOD OF PRODUCING THEREOF

(76) Inventors: Valerian PISHCHIK, Beer Sheva (IL); Joseph A. Sragowicz, Tel Aviv (IL); Vadim Livshits, Omer (IL); Kaydash Vitaly, Beer Sheva (IL)

Correspondence Address: EMPK & Shiloh, LLP;c/o Landon IP, Inc., 1700 Diagonal Road, Suite 450, Alexandria, VA, 22314, US

(21) Appl. No.: 11/832,698

(22) Filed: Aug. 2, 2007

(51) Int. Cl. B32B 3/02

(52) U.S. Cl. 428/53; 117/1; 156/304.6

(57) ABSTRACT

Some demonstrative embodiments of the invention include a welded crystal, and/or a method and/or system of producing thereof. In some demonstrative embodiments, the welded crystal welded crystal may include a welded portion joining at least two crystals, wherein the welded portion has a bending strength equal to at least fifty percent of the bending strength of at least one of the crystals. Other embodiments are described and claimed.

### FIELD

Embodiments of the invention relate generally to crystals and, more particularly to crystal products formed, for example, by joining at least two crystals, and to systems and methods of producing such crystal products.

### BACKGROUND

Crystals, e.g., corundum crystals, may be grown using various growing techniques

The complexity of growing a crystal, and accordingly the price of the crystal, may depend on the size and/or shape of the crystal. For example, the price of a crystal may increase logarithmically with the size of the crystal. In addition, the crystal growing techniques may allow growing crystals of a relatively limited range of shapes and sizes. Accordingly, it may be desired to join two or more crystals to produce a single large crystal.

“Sapphire & other corundum crystals”, E. Dobrovinskaya et al., Folio Institute for single crystals, 2002, pages 282-283 (hereinafter “Dobrovinskaya et al.”) describes welding two crystalline parts Dobrovinskaya et al. describe placing the parts in a cassette, which is put into a main heater and heated to a temperature of 2250-2300 Kelvin K). An additional heater in the form of a molybdenum or tungsten wire, having a diameter of 0.1-0.5 mm, is heated to 2350-2600K, while being moved along a junction between the parts. However, the welding technique described by Dobrovinskaya et al, leads to creation of curvilinear fronts of melting, and to curvilinear front of crystallization that leads to capture of impurity, formation of additional thermal stresses and to formation of block structure, as described in “Monocrystals of corundum: Problems of producing and quality”, Dobrovinskaja E. R, Pischik V. V, M 1988, part 1, p, 74, part 2 p. 2

### SUMMARY

Some demonstrative embodiments of the invention include a welded crystal, and/or a method and/or system of producing thereof.

According to some demonstrative embodiments of the invention, a welded crystal product may have a welded portion joining first and second crystals, wherein the welded portion has a bending strength equal to at least fifty percent of the bending strength of at least one of the crystals.

According to some demonstrative embodiments of the invention, a crack resistance coefficient of the welded portion is equal to or bigger than a crack resistance coefficient of at least one of the crystals.

According to some demonstrative embodiments of the invention, one or more of a dislocations density coefficient, a residual stress coefficient, and a block structure coefficient of the welded portion is equal to or less than one or more of a dislocations density coefficient, a residual stress coefficient, and a block structure coefficient, respectively, of at least one of the crystals.

According to some demonstrative embodiments of the invention, the welded portion and the crystals have the same type of crystalline structure.

According to some demonstrative embodiments of the invention, the welded portion contains substantially no inclusions.

According to some demonstrative embodiments of the invention, the welded portion has a length of more than 2 millimeters.

According to some demonstrative embodiments of the invention, the welded portion has a length of more than 100 millimeters.

According to some demonstrative embodiments of the invention, the welded portion has a length of more than 500 millimeters.

According to some demonstrative embodiments of the invention, the welded portion has a length of more than 1000 millimeters.

According to some demonstrative embodiments of the invention, the welded portion has a bending strength equal to at least seventy percent of the bending strength of at least one of the crystals.

According to some demonstrative embodiments of the invention, the welded portion has a bending strength equal to at least ninety percent of the bending strength of at least one of the crystals.

According to some demonstrative embodiments of the invention, the welded portion has a bending strength at least equal to the bending strength of at least one of the crystals.

According to some demonstrative embodiments of the invention, at least one of a length and a width of the welded crystal is at least two millimeters.

According to some demonstrative embodiments of the invention, at least one of the length and width of the welded crystal is at least 100 millimeters.

According to some demonstrative embodiments of the invention, at least one of the length and width of the welded crystal is at least 500 millimeters.

According to some demonstrative embodiments of the invention, at least one of the length and width of the welded crystal is at least 1000 millimeters.

According to some demonstrative embodiments of the invention, the welded portion has a width of less than 3 millimeters.

According to some demonstrative embodiments of the invention, at least one of the crystals comprises corundum ceramic.

According to some demonstrative embodiments of the invention, at least one of the crystals comprises Sapphire, Yttrium-Aluminum garnet, Al₂O₃:Ti, or Ruby.

According to some demonstrative embodiments of the invention, the crystals comprise at least one of a crystal plate, a crystal rod, a crystal pipe, and a crystal tuber.

According to some demonstrative embodiments of the invention, a system of welding at least first and second crystals to form a welded crystal may include a heating mechanism to heat the first and second crystals to a first temperature at least equal to a premelting temperature of the crystals, and to heat a welding element to a second temperature higher than the first temperature; and a movement mechanism to generate relative motion along at least first and second directions between the welding element and a welding zone between the crystals.

According to some demonstrative embodiments of the invention, the system may include at least one controller to control at least one of heating the crystals, heating the welding element, and generating the relative motion.

According to some demonstrative embodiments of the invention, the relative motion may include motion through the welding zone along at least one of the first and second directions.

According to some demonstrative embodiments of the invention, the at least first and second directions may include at least two generally perpendicular directions.

According to some demonstrative embodiments of the invention, the movement mechanism is to generate relative motion along the first direction at a speed of between 0.5 and 1.5 millimeter per hour.

According to some demonstrative embodiments of the invention, a speed of the motion along the first direction is approximately twice a speed of the motion along the second direction.

According to some demonstrative embodiments of the invention, the second temperatures is equal to at least a melting temperature of the crystals.

According to some demonstrative embodiments of the invention, the welding element is attached to a control-specimen, and wherein the second temperature is equal to at least a melting point of the control specimen.

According to some demonstrative embodiments of the invention, a melting temperature of the welding element is at least 300 degrees Celsius higher than a melting temperature of the crystals.

According to some demonstrative embodiments of the invention, the welding element may include a welding plate.

According to some demonstrative embodiments of the invention, a thickness of the welding plate is between 0.2 and 1.6 millimeter.

According to some demonstrative embodiments of the invention, a length of the welding plate is at least 1.5 times bigger than a height of the welding zone.

According to some demonstrative embodiments of the invention, at least one of the crystals comprises Sapphire, Yttrium-Aluminum garnet, Al2O3:Ti, or Ruby.

According to some demonstrative embodiments of the invention, the heating arrangement is to heat the welding element by passing electrical current through the welding element.

According to some demonstrative embodiments of the invention, a method of welding at least first and second crystals may include heating the first and second crystals to a first temperature equal to or higher than a premelting temperature of the crystals; beating a welding element to a second temperature higher than the first temperature; and generating relative motion along at least first and second directions between the welding element and a welding zone between the crystals.

According to some demonstrative embodiments of the invention, generating relative motion comprises generating relative motion through the welding zone along at least one of the first and second directions.

According to some demonstrative embodiments of the invention, the at least first and second directions may include at least two generally perpendicular directions.

According to some demonstrative embodiments of the invention, a speed of the motion along the first direction is approximately twice a speed of the motion along the second direction.

According to some demonstrative embodiments of the invention, heating the welding element to the second temperature may include heating the welding element to temperature equal to at least a melting temperature of the crystals.

According to some demonstrative embodiments of the invention, heating the welding element may include heating a welding plate,

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. Moreover, some of the blocks depicted in the drawings may be combined into a single function. The figures are listed below.

FIG. 1 is a schematic illustration of a welded crystal, in accordance with some demonstrative embodiments of the present invention;

FIG. 2 is a schematic illustration of a welded crystal portion including two crystals, in accordance with some demonstrative embodiments of the invention;

FIG. 3A schematically illustrates a circular welded crystal rod, in accordance with some demonstrative embodiments of the invention;

FIG. 3B schematically illustrates a curved welded crystal, in accordance with some demonstrative embodiments of the invention;

FIG. 4A depicts a welded crystal produced by welding two crystals using a welding wire;

FIG. 4B depicts a welded crystal produced by welding two crystals using a welding element, in accordance with some demonstrative embodiments of the invention;

FIGS. 4C and 4D depict micro-photos of the welded crystals of FIGS. 4A and 4B, respectively;

FIG. 4E schematically illustrates a graph depicting a curves corresponding to crack resistance values of the welded crystals of FIGS. 4A and 4B, respectively, as a function of a distance in micrometers from welded portions of the crystals of FIGS. 4A and 4B, respectively;

FIG. 5 is a schematic illustration of a system of welding at least two crystals, in accordance with some demonstrative embodiments of the invention; and

FIG. 6 is a schematic flow chart of a method of welding at least two crystals, in accordance with some demonstrative embodiments of the invention.

### DETAILED DESCRIPTION

In the following detailed description, numerous specific details are set forth in order to provide a thorough understanding of some demonstrative embodiments of the invention. However, it will be understood by those of ordinary skill in the art that embodiments of the invention may be practiced without these specific details. In other instances, well-known methods, procedures, components and circuits may not have been described in detail so as not to obscure embodiments of the invention.

Unless specifically stated otherwise, as apparent from the following discussions, it is appreciated that throughout the specification discussions utilizing terms such as “processing,” “computing,” “calculating,” “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Although embodiments of the invention are not limited in this respect, the term “crystal” as used herein may relate to an element, piece, part, component, or unit including any suitable crystalline material. The crystal may include, for example, a monocrystal, e.g., Sapphire, or a polycrystal, e.g., a corundum ceramic.

It should be understood that some embodiments of the invention may be used in a variety of applications. Although embodiments of the invention are not limited in this respect, one or more of the methods, devices and/or systems disclosed herein may be used in many applications, e.g., civil applications, military applications or any other suitable application. In some demonstrative embodiments of the invention, the methods, devices and/or systems disclosed herein may be used to produce a welded crystal having any suitable dimensions and/or shape, for example, a relatively large and/or thick crystal; a crystal having a relatively complex structure and/or shape, e.g., which may be difficult or practically impossible to be produced using conventional crystal growing techniques. In some demonstrative embodiments, the welded crystal may be implemented in the shape of a flask, a vessel, a crucible, a pipe, a closed volume, and the like. For example, a welded crystal as described herein may be implemented as a lens, e.g., an optical lens; a thermocouples protection tube; a dome or radome, e.g., a missile dome or radome; a window, for example, a window of an armored or protected vehicle, erg, an armored car; a utensil, e.g., a chemical utensil; a reactor, erg, a chemical reactor for transportation of aggressive substances; an implant, e.g., an orthopedic implant; a laser element tip; and/or in any other unit and/or device.

According to some demonstrative embodiments of the invention, a welded crystal product may be formed by welding at least two crystals along a welding zone. Welding the crystals may include heating the crystals to a first temperature equal to or higher than a premelting temperature of the crystals, heating a welding element to a second temperature higher than the first temperature, and generating relative motion between the welding element and the welding zone along at least first and second directions, e.g., as described in detail below.

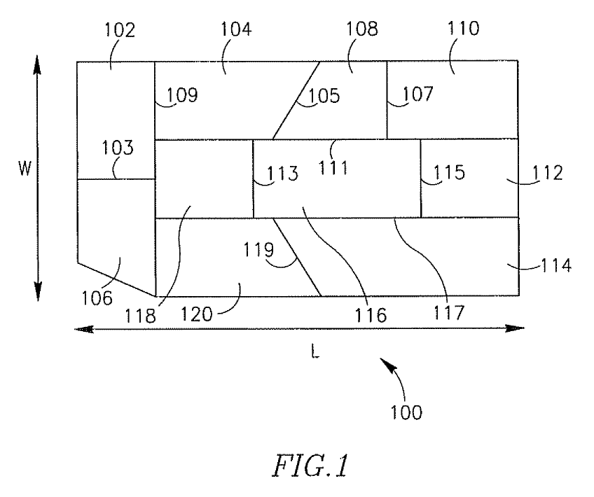

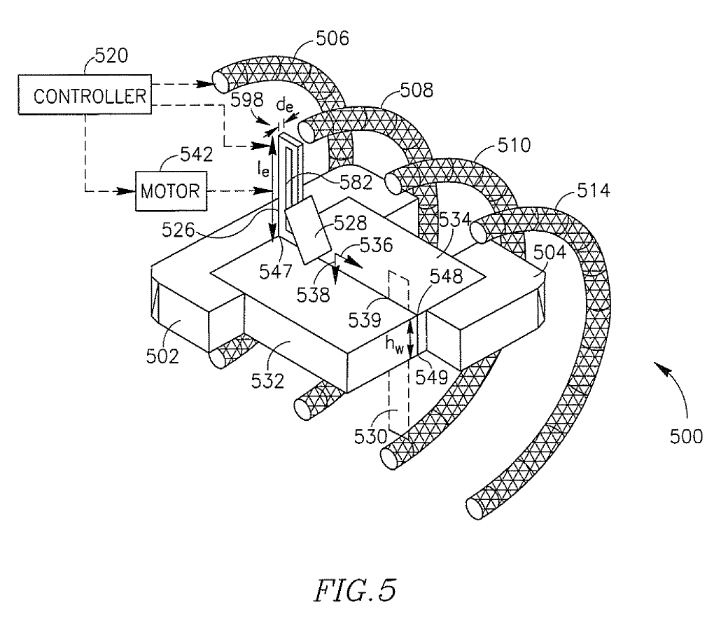

Reference is now made to FIG. 1, which schematically illustrates a welded crystal 100, in accordance with some demonstrative embodiments of the invention. Although embodiments of the invention are not limited in this respect, welded crystal 100 may be produced using a suitable welding method and/or system, e.g., as are described below with reference to FIGS. 5 and/or 6.

According to some demonstrative embodiments of the invention, welded crystal 100 may include at least first and second crystals joined by one or more welded portions For example, welded crystal 100 may include crystals 102, 104, 106, 108, 110, 112, 114, 116, 118 and 120 welded along welded portions 103, 105, 107, 109, 111, 113, 115 and 117, e.g., as described below.

According to some demonstrative embodiments of the invention, crystals 102, 104, 106, 108, 110, 112, 114, 116, 118 and 120 may include any suitable crystalline material having any suitable size, form or shape In some demonstrative embodiments, one or more of crystals 102, 104, 106, 108, 110, 112, 114, 116, 118 and 120 may include a crystal plate, e.g., a rectangular plate. In other demonstrative embodiments, welded crystal 100 may include one or more crystal rods and/or crystal tubes,

In some demonstrative embodiments, one or, more of crystals 102, 104, 106, 108, 110, 112, 114, 116, 118 and 120 may include corundum, e.g., Sapphire or Ruby; Yttrium-Aluminum Garnet (YAG); any suitable Oxide monocrystal; any suitable polycrystal; and/or any other suitable crystalline material.

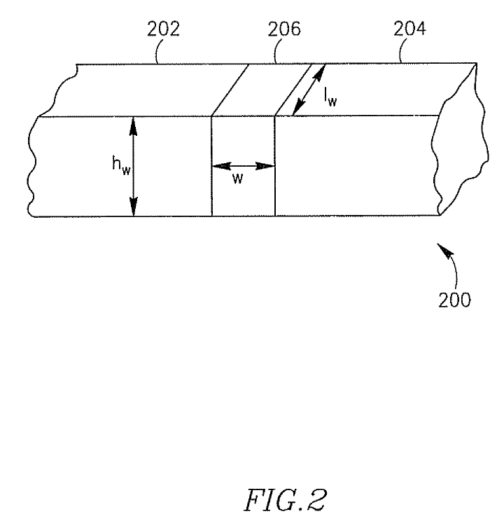

According to some demonstrative embodiments of the invention, a welded portion joining at least two crystals of welded crystal 100 (“the welded crystals”) may have a bending strength equal to at least fifty percent of the bending strength of at least one of the welded crystals, egg, as described in detail below with reference to FIG. 2. In one demonstrative example, welded portion 103 may have a bending strength equal to at least fifty percent of the bending strength of crystals 102 and/or 106; welded portion 109 may have a bending strength equal to at least fifty percent of the bending strength of crystals 102, 106, 104, 118 and/or 120; welded portion 105 may have a bending strength equal to at least fifty percent of the bending strength of crystals 104 and/or 108; welded portion 107 may have a bending strength equal to at least fifty percent of the bending strength of crystals 108 and/or 110; welded portion 111 may have a bending strength equal to at least fifty percent of the bending strength of crystals 104, 108, 110, 118, 116 and/or 112; welded portion 113 may have a bending strength equal to at least fifty percent of the bending strength of crystals 118 and/or 116; welded portion 115 may have a bending strength equal to at least fifty percent of the bending strength of crystals 116 and/or 112; welded portion 117 may have a bending strength equal to at least fifty percent of the bending strength of crystals 118, 116, 112, 120 and/or 114; and/or welded portion 119 may have a bending strength equal to at least fifty percent of the bending strength of crystals 120 and/or 114.

According to some demonstrative embodiments of the invention, at least one welded portion of welded portions 103, 105, 107, 109, 111, 113, 115, 117 and 119 may have one or more improved material-related characteristics compared to at least one of the welded crystals. In one example, one or more of a dislocations density coefficient, a residual stress coefficient, and/or a block structure coefficient of the welded portion may be equal to or smaller than one or more of a dislocations density coefficient, a residual stress coefficient, and/or a block structure coefficient, respectively, of the at least one of the welded crystals; and/or and a crack resistance coefficient of the welded portion may be equal to or higher than a crack resistance coefficient of at least one of the welded crystals, e.g., as described below with reference to FIG. 2

According to some demonstrative embodiments of the invention, at least one of welded portions 103, 105, 107, 109, 111, 113, 115, 117 and 119 may have a length of more than 2 millimeters (mm), for example, more than 100 mm, e.g., as described in detail below with reference to FIG. 2.

According to some demonstrative embodiments of the invention, welded crystal 100 may have any suitable dimensions. In one example, at least one of a length, denoted L, and a width, denoted W, of welded crystal 100 may be at least 2 mm. For example, The width W and/or the length L of welded crystal 100 may be at least 100 mm, for example, at least 500 mm, e.g. at least 1000 mm. In another example, the width W and/or length L of welded crystal 100 may be increased, without substantially any limitation, for example, by welding any suitable number of crystals, e.g., as described herein.

Reference is now made to FIG. 2, which schematically illustrates a segment of a welded crystal 200 including a welded portion 206 joining two crystals 202 and 204.

Although embodiments of the invention are not limited in this respect, one or more portions of welded crystal 100 (FIG. 1) may include welded crystal portion 200. For example, one or more of welded portions 103, 105, 107, 109, 111, 113, 115, 117 and 119 (FIG. 1) may be implemented in a similar manner to welded portion 206. Although embodiments of the invention are not limited in this respect, welded crystal 200 may be produced using a suitable welding method and/or system, e.g., as are described below with reference to FIGS. 5 and/or 6.

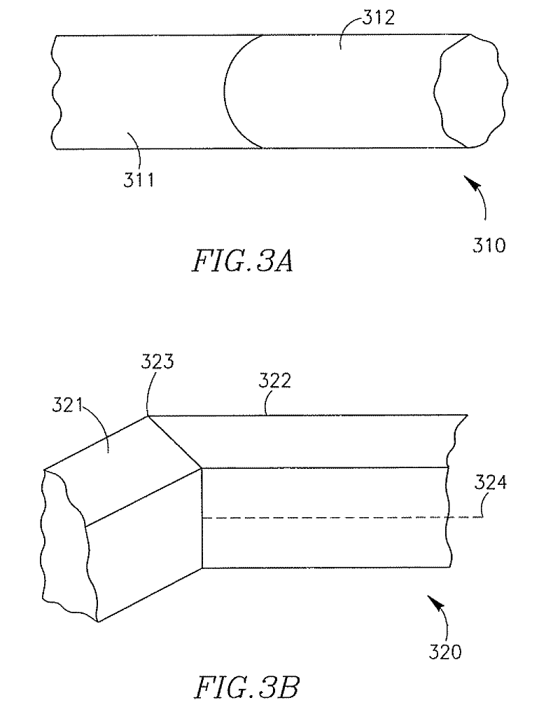

Although in the demonstrative embodiment of FIG. 2 welded crystal 200 has a shape of a plate or, a rectangular rod, embodiments of the invention are not limited in this respect and in other embodiments welded crystal 200 may have any suitable form, shape or size. In one example, the welded crystal may include a rod, pipe, or tube having any suitable shape, e.g., a rod, pipe, or tube having a substantially circular, semi-circular or elliptic cross-section. FIG. 3A schematically illustrates a welded crystal rod 310 formed by welding circular crystal rods 311 and 312, in accordance with some demonstrative embodiments of the invention. In another example, the welded crystal may have a curved shape. FIG. 3B schematically illustrates a curved welded crystal 320, in accordance with some demonstrative embodiments of the invention. Welded crystal 320 may crystal rods 321 and 322 joined along a welded portion 323, which is non-perpendicular to a longitudinal axis 324 of crystal rod 322. In other embodiments the welded crystal may have any other suitable form, shape or size.

Referring back to FIG. 2, according to one demonstrative embodiment of the invention, crystals 202 and 204 may include two Sapphire plates, each having a length of 60 mm, a width of 60 mm, and a height of 8 mm. In another demonstrative embodiment, crystals 202 and 204 may include two Sapphire rods, each having a length of 60 mm, and a radius of 12 mm. In yet another demonstrative embodiment, crystals 202 and 204 may include two monocrystal rods of a YAG, each having a length of 60 mm and a radius of 5.5 mm. In other embodiments, crystals 202 and 204 may be formed of any suitable crystalline material, and may have any suitable form, shape and/or size.

According to some demonstrative embodiments of the invention, welded portion 206 may have the same type of crystalline structure as crystals 202 and 204. In one example, welded portion 206 may include a monocrystal, e.g., if crystals 202 and 204 include monocrystals. In another example, welded portion 206 may include a polycrystal, e.g., if crystals 202 and 204 include polycrystals.

According to some demonstrative embodiments of the invention, welded portion 206 may have a bending strength equal to at least fifty percent of the bending strength of at least one of crystals 202 and 204.

In one demonstrative example, welded portion 206 may have a bending strength equal to at least sixty percent, e.g., at least seventy percent, of the bending strength of at least one of crystals 202 and 204. In another example, welded portion 206 may have a bending strength equal to at least seventy five percent, e.g., at least eighty percent, of the bending strength of at least one of crystals 202 and 204. In yet another example, welded portion 206 may have a bending strength equal to at least ninety percent, e.g., at least ninety five percent, of the bending strength of at least one of crystals 202 and 204. In yet another example, welded portion 206 may have a bending strength equal to at least the bending strength of at least one of crystals 202 and 204. In yet another example, welded portion 206 may have a bending strength at least ten percent, e.g., at least twenty percent, bigger than the bending strength of at least one of crystals 202 and 204.

According to some demonstrative embodiments of the invention, welded portion 206 have a bending strength of more than 200 Mega Pascal (MPa), for example, at least 400 MPa, e.g., at least 600 MPa, if for, example, crystals 202 and/or 204 include Sapphire.

According to some demonstrative embodiments of the invention, welded portion 206 may have a length, denoted l_{w}, of more than 2 mm, for example, at least 100 mm, e.g., at least 200 mm. In one example, welded portion 206 may have a length of at least 500 mm, for example, at least 1000 mm.

According to some demonstrative embodiments of the invention, welded portion 206 may have a width, denoted w, of less than 3 mm, for example, between 03 mm and 2.1 mm.

According to some demonstrative embodiments of the invention, welded portion 206 may have a height, denoted h, of at least 2 mm, e.g. between 2 mm and 400 mm.

According to some demonstrative embodiments of the invention, welded portion 206 may have one or more improved material-related characteristics compared to at least one of crystals 202 and 204. In one example, a dislocations density coefficient, a residual stress coefficient and/or a block structure coefficient of welded portion 206 may be equal to or smaller than a dislocations density coefficient, a residual stress coefficient and/or a block structure coefficient, respectively, of crystals 202 and/or 204; and/or a crack resistance coefficient, denoted K_{C}, of welded portion 206 may be equal to or bigger than a crack resistance coefficient of crystals 202 and/or 204.

In one example, crystals 202 and 204 may include sapphire crystals having a dislocations density coefficient of, for example, approximately 2*10⁵ cm²; a residual stress coefficient of, for example, approximately 2.5 Kg/mm; a block structure coefficient, denoted Σp, of, for example, approximately 1 mm⁻¹; and/or a crack resistance coefficient of, for example, approximately 3 MN·m^{-3/2}. According to this example, welded portion 206 may have a dislocations density coefficient equal to or less than 2*10⁵ cm⁻², for example, between approximately 0.6*10⁵ cm⁻² and 2*10⁵ cm⁻²; a residual stress coefficient equal to or less than 2.5 Kg/mm, for example, between approximately 2 Kg/mm and 2.5 Kg/mm; a block structure coefficient equal to or less than 1 mm⁻¹, for example, between approximately 0.01 mm⁻¹ and 1 mm⁻¹; and/or a crack resistance coefficient equal to or bigger than 3NM·m^{-3/2}, for example, between 3 MN·m^{-3/2} and 5 MN·m^{-3/2}.

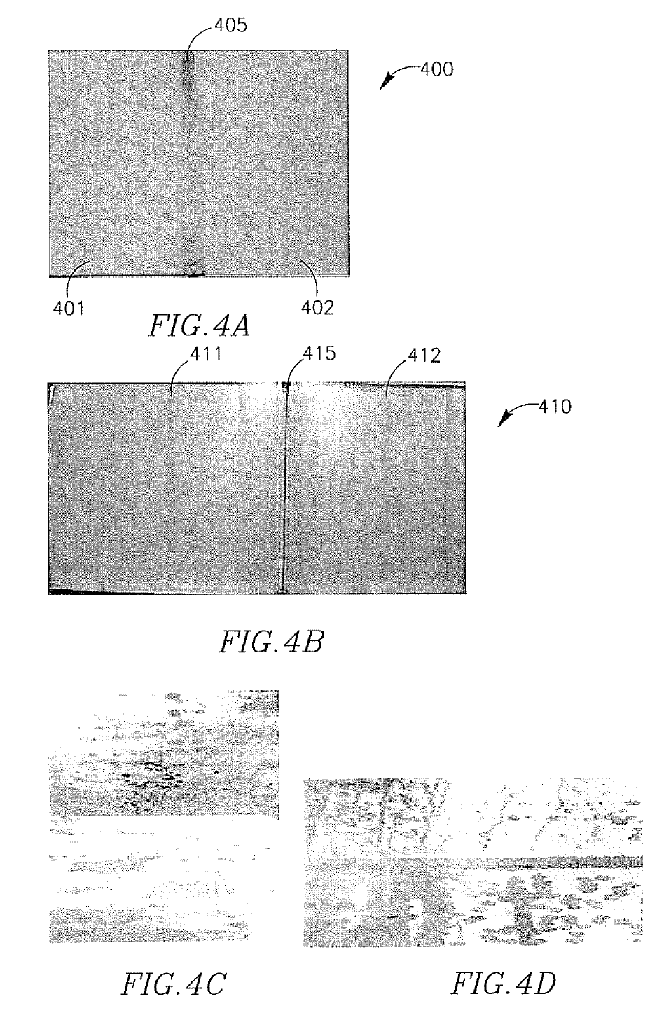

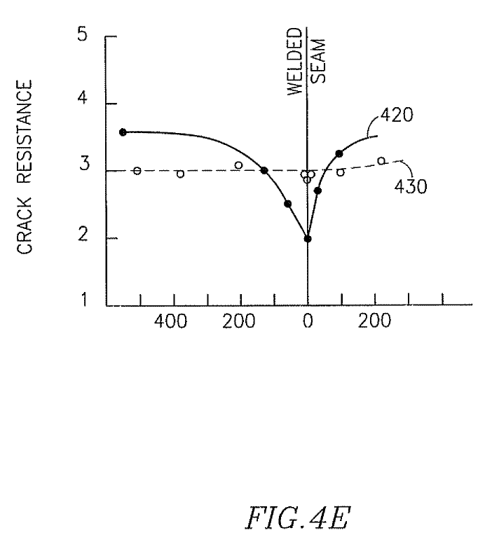

FIG. 4A depicts a welded crystal 400 including two crystals 401 and 402 joined along a welded portion 405 using a welding wire in accordance with the description of “Sapphire & other corundum crystals”, E. Dobrovinskaya et al., Folio Institute for single crystals, 2002, pages 282-283, the entire disclosure of which is incorporated herein by reference; and FIG. 4B depicts a welded crystal 410 including two crystals 411 and 412 joined along a welded portion 415, in accordance with some demonstrative embodiments of the invention. FIGS. 4C and 4D depict micro-photos of welded crystals 400 and 410, respectively. FIG. 4E schematically illustrates a graph depicting a curve 420 corresponding to crack resistance values of welded crystal 400, and a curve 430 corresponding to crack resistance values of welded crystal 410, as a function of a distance in micrometers from welded portions 405 and 415, respectively.

As shown in FIGS. 4A, and 4C welded portion 405 includes a relatively large number of defects and/or inclusions compared to crystals 401 and 402. As shown in FIGS. 4B and 4C, welded portion 415 includes only a small angle border, and a slightly increased density of single dislocations compared to crystals 411 and 412. As also shown in FIGS. 4B and 4C, welded portion 415 contains substantially no inclusions.

As shown in FIG. 4E, the crack resistance may decrease from approximately 3MN*m^{-3/2} along crystals 401 and 402 to approximately 2 MN*m^{-3/2} at welded portion 405. As also shown in FIG. 4F, the crack resistance of welded portion 415 may have a value of approximately 3MN*m^{-3/2}, which is substantially equal to the crack resistance of crystals 411 and 412.

According to some demonstrative embodiments of the invention, directed crystallization occurring during the welding of crystals 411 and 412 along welded portion 415 may result in segregation of impurities along a crystallization front, e.g., as described below. As a result, impurities may shift from within welded portion 415 to crystals 411 and 412, and/or from crystals 411 and 412 into welded portion 415. Accordingly, a brightness of welded portion 415 may be different than a lightness/brightness of crystals 411 sand 412, e.g., as shown in FIG. 4B. In one example, welded portion 415 may be lighter than crystals 411 and 412, e.g., if crystals 411 and 412 include Sapphire or YAG. In another example, welded portion 415 may be darker than crystals 411 and 412.

Reference is now made to FIG. 5, which schematically illustrates a system 500 of welding at least two crystals, in accordance with some demonstrative embodiments of the invention. Although embodiments of the invention are not limited in this respect, according to some demonstrative embodiments system 500 may be implemented to produce welded crystal 100 (FIG. 1), by welding one or more of crystals 102, 104, 106, 108, 110, 112, 114, 116, 118 and/or 120 (FIG. 1); and/or welded crystal portion 200 (FIG. 2).

According to some demonstrative embodiments of the invention, system 500 may include a welding element 526 to weld a first crystal 532 and a second crystal 534, e.g., as described in detail below. System 500 may also include a heater arrangement to heat crystals 532 and 534 to a first temperature, denoted T1, and to heat welding element 526 to a second temperature, denoted T2, erg, as described in detail below.

According to some demonstrative embodiments of the invention, the heater arrangement may include one or more first heaters, e.g., including heaters 506, 508, 510, and/or 514, to heat crystals 532 and/or 534; and a second heater 582, which may be implemented as part of welding element 526. In one example, heater 582 may include an electrical heater. Accordingly, welding element 526 may be heated by passing electrical current through heater 582.

According to some demonstrative embodiments of the invention, the temperature T1 may be substantially equal to a premelting temperature of crystals 532 and 534. In one example, the temperature T1 may be higher than a temperature of plasticity of crystals 532 and 534 material, and lower than a temperature of fusion of crystals 532 and 534. For example, the temperature T11 may be approximately 1900° C. if, for example, crystals 532 and 534 include Sapphire; approximately 1950° C. if, for example, crystals 532 and 534 include Ruby; approximately 1800° C. if, for example, crystals 532 and 534 include YAG; or approximately 1750° C. if, for example, crystals 532 and 534 include Corundum ceramics.

According to some demonstrative embodiments of the invention, the temperature T2 may be substantially equal to a melting temperature of crystals 532 and 534. In one example, the temperature T2 may be approximately 10° C. higher than the temperature of fusion of crystals 532 and 534. For example, the temperature T2 may be approximately 2050° C. if, for example, crystals 532 and 534 include Sapphire; approximately 2060° C. if, for example, crystals 532 and 534 include Ruby; approximately 1980° C. if; for example, crystals 532 and 534 include YAG; or approximately 1950° C. if, for example, crystals 532 and 534 include Corundum ceramics.

According to some demonstrative embodiments of the invention, a melting temperature of welding element 526 may be at least 300 degrees Celsius higher than the melting temperature of crystals 532 and 534.

According to some demonstrative embodiments of the invention, welding element 526 may include a welding plate, e.g., having a rectangular shape. In other embodiments, welding element may have any other suitable shape.

According to some demonstrative embodiments of the invention, welding element 526 may have a thickness, denoted dₑ, of between 0.2 and 1.6 mm, A length, denoted l_{c}, of welding element 526 may be at least 1.5 times bigger than the height h_{w} of a zone 539 between crystals 532 and 534.

According to some demonstrative embodiments of the invention, system 500 may also include at least one holder to hold crystals 532 and 534. The holder may include, for example, any suitable mandrel, tool, or clamp. In one example, the holder includes mandrel elements 502 and 504.

According to some demonstrative embodiments of the invention, system 500 may also include a movement mechanism, e.g., a motor 542, to generate relative motion along at least first and second directions 536 and 538, respectively, between welding element 526 and a welding zone 539 between crystals 532 and 534, e.g., as described in detail below. Motor 542 may include any suitable motor e.g., an electrical motor. In one example, motor 542 may move welding element 526, e.g., while crystals 532 and 534 are maintained at a constant location. In another example, motor 542 may move crystals 532 and 534, erg, while welding element 526 is maintained at a constant location. In yet another example, motor 542 may move both welding element 526 and crystals 532 and 534.

According to some demonstrative embodiments of the invention, directions 536 and 538 may be substantially perpendicular to one another. In one example, direction 536 may be substantially parallel to a longitudinal axis of welding zone 539, defined, for example, by a top left end 547 and a top right end 548 of welding zone 539; and direction 538 may be substantially perpendicular to the longitudinal axis.

According to some demonstrative embodiments of the invention, the movement mechanism may generate relative motion of welding element 526 through welding zone 539 along at least one of directions 536 and 538. For example, motor 542 may move welding element 526 from a first position 598, e.g., at end 547, to a second position 530 at a bottom right end 549 of welding zone 539.

According to some demonstrative embodiments of the invention, the movement mechanism may generate the relative motion along direction 536 at a first speed of between 0.5 and 1.5 mm per hour.

According to some demonstrative embodiments of the invention, the movement mechanism may generate the relative motion along direction 538 at a speed of approximately half the speed of relative motion along direction 536.

According too some demonstrative embodiments of the invention, system 500 may also include at least one controller 520 to control the heating of heaters 506, 508, 510, and/or 514; the heating of welding element 526; and/or relative motion between welding element 526 and crystals 532 and 534, as described in details below. In one example, heaters 506, 508, 510, 514, and 582 may include electrical heaters, which may be heated by passing electrical current, and controller 520 may control the electrical current provided to heaters 506, 508, 510, 514, and 582. Controller may also control the relative motion between welding element 526 and welding zone 539, for example, by controlling the operation of motor 542.

Although embodiments of the invention are not limited in this respect, one or more elements of system 500, e.g., heaters 506, 508, 510 and 514, and/or mandrel elements 502 and 502, may be part of, a crystal growing system, which may be used, for example, to produce crystals 532 and/or 534.

According to some demonstrative embodiments of the invention, system 500 and/or welding element 526 may be configured to create welding conditions, e.g., a substantially flat front of crystallization, which may result in directed crystallization during the motion of welding element 526 through welding zone 539, as described below. The flat front of crystallization and/or directed crystallization may result in a decreased amount of structure defects, which may be formed within a resulting welded portion.

According to some demonstrative embodiments of the invention, the heating of a welding zone during a welding process may result in fusion and/or crystallization within the welding zone. Accordingly, the heating of the welding zone may result in a liquid phase dissociation within the welding zone; changes of a chemical structure within the welding zone, e.g., due to segregation and/or dislodgment of impurities; formation of internal residual stresses within the welding zone; and/or occurrence of point and/or linear defects within the welding zone.

According to some demonstrative embodiments of the invention, the liquid phase dissociation may be temperature dependant, e.g., the higher the temperature the higher the degree of dissociation, A degree of the segregation within a zone of crystallization, which may be formed during the welding process, may depend on a temperature distribution within the zone of crystallization. For example, a relatively low degree of segregation may be achieved by maintaining a relatively uniform temperature distribution within the zone of crystallization, while a non-uniform distribution of the temperature within the zone of crystallization may result in a higher degree of segregation. The non-uniform temperature distribution may also result in formation of internal residual stresses within the welding zone. Such residual stresses may cause deformation and/or weakening of the welding zone. Formation of a curvilinear front of crystallization within the welding zone may result in an increased amount of impurities, thermal stress, and/or, formation of blocks within the welding zone.

According to some demonstrative embodiments of the invention, the configuration of one or more elements of system 500 may enable to maintain a substantially uniform temperature distribution within the zone of crystallization, e.g., along a surface of a crystal being in contact with welding element 526, e.g., as described below.

According to some demonstrative embodiments of the invention, the configuration of system 500 may enable to generate a substantially flat front of crystallization and/or directed crystallization within welding zone 539. Such a crystallization front may reduce or substantially exclude formation of structure defects, which may develop within the welding zone as a result of the welding process.

According to some demonstrative embodiments of the invention, moving welding element 526 along a single direction, e.g., only along direction 538, during the welding process may result in contact of welding element 526 with areas of liquid phase dissociation within welding zone 539 during a relatively long time period. Such contact may result in an increased non-uniformity of the temperate distribution within welding zone 539; a local change of one or more dimensions of welding element 526; and/or “pollution” of the welding zone by oxides and/or Oxide films.

According to some demonstrative embodiments of the invention, the relative motion between welding element 526 and welding zone 539 along at least two directions 536 and 538 may result in a reduction of a time period (“the contact period”) in which welding element 526 is in contact with a dissociated portion of welding zone 539 compared, for example, to a contact period when relative motion is generated along only one direction, e.g., only direction 538. Accordingly, generating the relative motion between welding element 326 and welding zone 539 along directions 536 and 538 may result in a smaller variance of the temperature in the zone of crystallization and, consequently, in a reduction of impurities in welding zone 539. Generating the relative motion along directions 536 and 538 may also result in a substantially uniform temperature distribution within the zone of crystallization, which in turn may result in a decreased level of oxidation of welding element 526.

According too some demonstrative embodiments of the invention, system 500 may be adapted to control the temperature T2 of welding element 526 in order, for example, to avoid deformation and/or breaking of welding element 526, and/or to avoid overheating of the crystals, as described in detail below.

According to some demonstrative embodiments of the invention, a corundum crystal, e.g., ruby or sapphire, may undergo the following chemical reaction when subject, for example, to a relatively low superheating temperature, e.g., a temperature of between 2040° C. and 2060° C.:

Al₂O₃ [symbol] AlO₂+AlO;

2Al₂O₃ [symbol] Al+3AlO₂.

According to some demonstrative embodiments of the invention, the corundum crystal may undergo the following chemical reaction when subject, for example, to a relatively medium superheating temperature, e.g., a temperature of between 2060° C. and 2080° C.:

AlO₂ [symbol] AlO+O;

Al₂O₃ [symbol] Al₂O₂+O;

Al₂O₃ [symbol] Al₂O+2O; +O;

Al₂O₃<=>AlO+Al.

According to some demonstrative embodiments of the invention, the corundum crystal may undergo the following chemical reaction when subject, for example, to a relatively high superheating temperature, e.g., a temperature of between 2080° C. and 2150° C.:

Al₂O₃ [symbol] 2AlO+3O;

AlO [symbol] Al+O;

AlO₂ [symbol] Al+2O.

According to the above, active Oxygen may be released during the process of welding crystals 532 and 534 if for, example, crystals 532 and/or 534 are subject to the relatively high superheating temperature. The active Oxygen may interact with welding element 526. Oxidation of welding element 526 may result in a deformation of welding element 526, e.g., a change in a shape and/or one or more dimensions of welding element 526. Such deformation of welding element 526 may result in a variation of the temperature in the zone of crystallization, which may lead to impurities within welding zone 539, e.g., as described above.

According to some demonstrative embodiments of the invention, the temperature P2 of welding element 526 may be controlled based on a temperature at which crystals 532 and/or 534 may actually begin to melt (“actual melting temperature”), Heating welding element 526 to approximately the actual melting temperature of crystals 532 and/or 534 may prevent deformation of welding element which may result, for example, from heating welding element 526 to a temperature lower than the actual melting temperature; and/or overheating of welding zone 539, which may lead to an increase of a degree of dissociation, and to an increase of concentration of atomic oxygen in the crystallization zone, which in turn may result in an increase in a degree of interaction of welding element 526 with melted crystal material within welding zone 539.

According to some demonstrative embodiments of the invention, welding element 526 may be in maintained contact with a control specimen 528, e.g., during at least part of the welding process Control specimen 528 may be formed of a material having a melting temperature substantially equal to a melting temperature of crystals 532 and/or 534. In one example, control specimen 528 may be formed of the same material of crystals 532 and/or 534.

According to some demonstrative embodiments of the invention, the temperature T2 of welding element 526 may be controlled based on a temperature of control specimen 528 and/or an observed condition of control specimen 528. For example, welding element 526 may be heated to temperature T2 at which control specimen 528 is observed to begin to melt, which may indicate welding element 526 has reached approximately the melting temperature of crystals 532 and/or 534, e.g., approximately 10 to 15 degrees Celsius higher than the melting temperature of crystals 532 and 534.

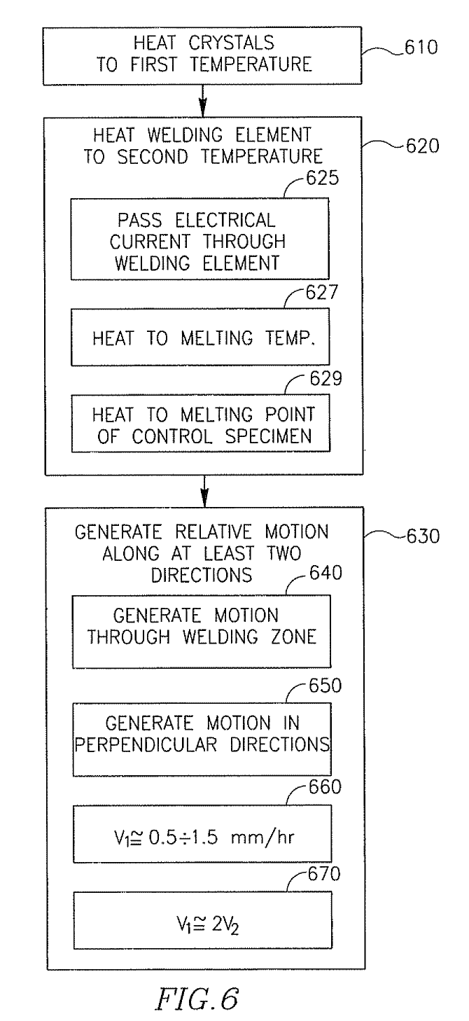

Reference is now made to FIG. 6, which schematically illustrates a method of welding at least first and second crystals. Although embodiments of the invention are not limited in this respect, one or more operations of the method of FIG. 6 may be implemented by a welding system, e.g., system 500 (FIG. 5), to generate a welded crystal, e.g., crystal 100 (FIG. 1) and/or crystal 200 (FIG. 2).

As indicated at block 610, in some demonstrative embodiments the method may include heating the first and second crystals to a first temperature equal to or higher than a premelting temperature of the crystals Heating the first and second crystals may be performed, for example, by one or more heaters, e.g., heaters 506, 508, 510 and 514 (FIG. 5).

As indicated at block 620, in some demonstrative embodiments the method may also include heating a welding element to a second temperature higher than the first temperature. As indicated at block 625, in some demonstrative embodiments heating the welding element may include, for example, passing electrical current through the welding element, e.g., as described above with reference to FIG. 5.

As indicated at block 627, in some demonstrative embodiments the second temperature may include for example a temperature substantially equal to at least the melting temperature of the crystals, e.g., as described above.

As indicated at block 629, in some demonstrative embodiments heating the welding element may include heating the welding element to at least a melting point of a control specimen in contact with the welding element, e.g., as described above with reference to FIG. 5.

As indicated at block 630, in some demonstrative embodiments the method may also include generating relative motion along at least first and second directions between the welding element and a welding zone between the crystals. Generating the relative motion may include, for example, moving the welding element and/or the crystals, e.g., as described above with reference to FIG. 5.

As indicated at block 640, in some demonstrative embodiments generating the relative motion may include generating motion through the welding zone along at least one of the first and second directions. For example, generating the relative motion may include moving the welding element from position 598 to position 530 as described above with reference to FIG. 5.

As indicated at block 650, in some demonstrative embodiments generating the relative motion may include generating the relative motion in at least two perpendicular directions, e.g., directions 536 and 538 (FIG. 5).

As indicated at block 660, in some demonstrative embodiments generating the relative motion may include generating the relative motion along the first direction at a speed, denoted V1, of between 0.5 and 1.5 mm per hour, e.g., as described above with reference to FIG. 5.

As indicated at block 670, in some demonstrative embodiments generating the relative motion may include generating the relative motion along the first direction at a speed approximately twice a speed of the motion, denoted V2, along the second direction, e.g., as described above with reference to FIG. 5.

Embodiments of the invention may be implemented by software, by hardware, or by any combination of software and/or hardware as may be suitable for specific applications or in accordance with specific design requirements. Embodiments of the invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A welded crystal product having a welded portion joining first and second crystals, wherein said welded portion has a bending strength equal to at least fifty percent of the bending strength of at least one of said crystals.

2. The welded crystal of claim 1, wherein a crack resistance coefficient of said welded portion is equal to or bigger than a crack resistance coefficient of at least one of said crystals.

3. The welded crystal of claim 1, wherein one or more of a dislocations density coefficient, a residual stress coefficient, and a block structure coefficient of said welded portion is equal to or less than one or more of a dislocations density coefficient, a residual stress coefficient, and a block structure coefficient, respectively, of at least one of said crystals.

4. The welded crystal of claim 1, wherein said welded portion and said crystals have the same type of crystalline structure.

5. The welded crystal of claim 1, wherein said welded portion contains substantially no inclusions.

6. The welded crystal of claim 1, wherein said welded portion has a length of more than 2 millimeters.

7. The welded crystal of claim 6, wherein said welded portion has a length of more than 100 millimeters.

8. The welded crystal of claim 7, wherein said welded portion has a length of more than 500 millimeters.

9. The welded crystal of claim 8, wherein said welded portion has a length of more than 1000 millimeters.

10. The welded crystal of claim 1, wherein said welded portion has a bending strength equal to at least seventy percent of the bending strength of at least one of said crystals.

11. The welded crystal of claim 10, wherein said welded portion has a bending strength equal to at least ninety percent of the bending strength of at least one of said crystals.

12. The welded crystal of claim 11, wherein said welded portion has a bending strength at least equal to the bending strength of at least one of said crystals.

13. The welded crystal of claim 1, wherein at least one of a length and a width of said welded crystal is at least two millimeters.

14. The welded crystal of claim 13, wherein at least one of the length and width of said welded crystal is at least 100 millimeters.

15. The welded crystal of claim 14, wherein at least one of the length and width of said welded crystal is at least 500 millimeters.

16. The welded crystal of claim 15, wherein at least one of the length and width of said welded crystal is at least 1000 millimeters.

17. The welded crystal of claim 1, wherein said welded portion has a width of less than 3 millimeters.

18. The welded crystal of claim 1, wherein at least one of said crystals comprises corundum ceramic.

19. The welded crystal of claim 1, wherein at least one of said crystals comprises Sapphire, Yttrium-Aluminum garnet, Al₂O₃:Ti, or Ruby.

20. The welded crystal of claim 1, wherein said crystals comprise at least one of a crystal plate, a crystal rod, a crystal pipe, and a crystal tube.

21. A system of welding at least first and second crystals to form a welded crystal, the system comprising:
a heating mechanism to heat said first and second crystals to a first temperature at least equal to a premelting temperature of said crystals, and to heat a welding element to a second temperature higher than said first temperature; and
a movement mechanism to generate relative motion along at least first and second directions between said welding element and a welding zone between said crystals.

22. The system of claim 21 comprising at least one controller to control at least one of heating said crystals, heating said welding element, and generating said relative motion.

23. The system of claim 21, wherein said relative motion comprises motion through said welding zone along at least one of said first and second directions.

24. The system of claim 21, wherein said at least first and second directions comprise at least two generally perpendicular directions.

25. The system of claim 21, wherein said movement mechanism is to generate relative motion along said first direction at a speed of between 0.5 and 1.5 millimeter per hour.

26. The system of claim 21, wherein a speed of the motion along said first direction is approximately twice a speed of the motion along said second direction.

27. The system of claim 21, wherein said second temperatures is equal to at least a melting temperature of said crystals.

28. The system of claim 21, wherein said welding element is attached to a control-specimen, and wherein said second temperature is equal to at least a melting point of said control specimen.

29. The system of claim 21, wherein a melting temperature of said welding element is at least 300 degrees Celsius higher than a melting temperature of said crystals.

30. The system of claim 21, wherein said welding element comprises a welding plate.

31. The system of claim 30, wherein a thickness of said welding plate is between 0.2 and 1.6 millimeter.

32. The system of claim 30, wherein a length of said welding plate is at least 1.5 times bigger than a height of said welding zone.

33. The system of claim 21, wherein at least one of said crystals comprises Sapphire, Yttrium-Aluminum garnet, Al₂O₃:Ti, or Ruby.

34. The system of claim 21, wherein said heating arrangement is to heat said welding element by passing electrical current through said welding element.

35. A method of welding at least first and second crystals, the method comprising:
heating said first and second crystals to a first temperature equal to or higher than a premelting temperature of said crystals;
heating a welding element to a second temperature higher than said first temperature; and
generating relative motion along at least first and second directions between said welding element and a welding zone between said crystals.

36. The method of claim 35, wherein generating relative motion comprises generating relative motion through said welding zone along at least one of said first and second directions.

37. The method of claim 35, wherein said at least first and second directions comprise at least two generally perpendicular directions.

38. The method of claim 35, wherein a speed of the motion along said first direction is approximately twice a speed of the motion along said second direction.

39. The method of claim 35, wherein heating said welding element to said second temperature comprises heating said welding element to temperature equal to at least a melting temperature of said crystals.

40. The method of claim 35, wherein heating said welding element comprises heating a welding plate.
